(19) United States
(12) Patent Application Publication
(10) Pub. No.: US 2012/0110032 A1
(43) Pub. Date: May 3, 2012

(54) METHODS AND SYSTEMS FOR CONCATENATING AND TRANSFERRING WEB ACCESSIBLE CONTENT AND METADATA BETWEEN NETWORKED COMPUTERS OR MOBILE DEVICES

(75) Inventors: Benjamin Robison, Long Island City, NY (US); David Foote, San Francisco, CA (US)

(73) Assignee: Fractor, LLC, Long Island City, NY (US)

(21) Appl. No.: 12/916,172

(22) Filed: Oct. 29, 2010

(51) Int. Cl. G06F 17/30

(52) U.S. Cl. 707/812; 707/E17.005

(57) ABSTRACT

Systems and methods for concatenating web accessible content may receive a plurality of URLs, user data, user identifying data, metadata, a user message, at least one user intention, and at least one context. The plurality of URLs may be related to a distinct item of web accessible content. The user intention may be a description of a desired action to be taken by future users. The context may be a conceptual frame-of-reference for possible concatenations between the web accessible content. Systems and methods may concatenate the plurality of URLs, user data, user identifying data, metadata, and user intention within the context to create concatenated content; create one or more new URLs for the concatenated content; store the concatenated content or one or more new URLs and user message in the one or more databases; and output the one or more new URLs together with the user message.

### FIELD OF THE INVENTION

The present invention relates to web publishing and, more specifically, to systems and methods for concatenating and transferring web accessible content.

### BACKGROUND OF INVENTION

In recent years, systems for providing access to electronic information, such as electronic newspapers or blogs, by utilizing the World Wide Web (WWW) and files in HyperText Markup Language (HTML) or eXtensible HyperText Markup Language (XHML), have proliferated. Users may peruse interrelated content on the WWW by accessing content stored on servers throughout the WWW via hyperlinks that connect web pages. Users often utilize Internet web browsers to receive and display information. Hyperlinks are instructions to the browser to replace the current web page with a new web page at another URL address. Users can access web content by using Hypertext Transport Protocol (HTTP), where each web page contains a unique universal resource locator (URL) address.

Adding content or commentary to existing web pages has been historically controlled by permission of content owners through server-side permissions. Typically, a user may add a comment to a particular web page only if the owner of the page provides a suitable program that allows the user to add text to the page such as a wiki or a commenting system.

As such, the current WWW may be considered an owner controlled system, lacking the ability for users to add relevant content to pages according to their own discretion.

Users have long been able to attach files to emails and thus share concatenated information such as an email and an attached file but this requires the use of more than one program (an email client and a browser) or multiple browser windows and awkward cut and paste activities. Additionally, this relies entirely on the search capabilities of the user to find and associate content. Other limitations of this approach are that emails go to a specific distribution list, and are not searchable or accessible by the general public or through social network communication streams.

More recently, web annotation has facilitated the addition of user content to existing web pages without the page owner's permission. This has allowed users to make comments on existing pages that are then available to the user and other users who have adopted the annotation software by downloading extensions to user browsers.

In addition, methods exist to allow users to group multiple web pages and output content from the group and share the grouping with others through enhancements to web browsers.

However, needs exist for a system that propagates web annotations and concatenations via email or social networks without client-based software. Existing systems require the adoption of annotation software to visualize the annotations or browser extensions to group existing web pages. In neither case do users have the ability to simultaneously view original web content and the concatenated information on a server-based interface for interacting with or sharing concatenated information, and metadata. In addition, no methods or systems exist that allows users to access potentially associable content by presenting users with content previously saved in a database when the user accesses such an interface.

Needs also exist for methods or systems exist that allow users to access different types of potentially associable content by switching the context of interest (i.e. from social action, presenting a list of possible donations to commerce, presenting a list of purchasable books). In addition, needs exists for methods and systems to concatenate a user's intention for future users' actions with concatenated content.

In a more general context, discussions surrounding the semantic web point to the possibility of a systematic framework for web pages containing metadata that would allow the web pages themselves to contain a basic framework for understanding of the nature or relevancy of the content of other web pages. This framework has yet to gain widespread acceptance, but hints at the need for systems that make relevant connections between web accessible content and allows users to interact with such connected content. While the semantic web calls for consistent metadata that can be used to auto-correlate information between sites, it does not allow for connections between sites regardless of metadata. The semantic web is a framework for encoding information into sites to make automated operations more meaningful.

Additionally, social networks offer users a new delivery channel, giving them the ability to share information with multiple users in a single step, for instance by posting on a FACEBOOK profile or TWITTER feed. Real time social networks create a persistent stream of new data that can be searched by various keywords and topics. Whereas classic web search indicates popularity by site linkages, real time social networks indicate popularity by user reposts or re-tweets. This allows for the intelligent filtering of useful information and points to the value of social networks in sharing such useful information, as well as a general desire for legitimization of information through direct personal interaction.

Needs exist for methods and systems that allow the concatenation and distribution of web accessible content that takes advantage of the metadata and legitimacy offered by social networks and personalized recommendations. For example, there is a need for news and web content to be made actionable. A system that would allow the concatenation of volunteer or donation opportunities with web content would improve both the social impact and interactivity of the Internet and the general welfare as a tool for acting on the news would serve as a democratizing element. Under such a system, anyone anywhere could potentially leverage this method and system to impact the daily flow of events world wide.

### SUMMARY OF INVENTION

Embodiments of the present invention solve many of the problems and/or overcome many of the drawbacks and disadvantages of the prior art by providing systems and methods for concatenation and transfer of web accessible content that will allow users or computers to add content, contexts (i.e. conceptual frames-of-reference for recommended concatenations), action opportunities, metadata and/or commentary to existing web pages or synthesize a plurality of web accessible content throughout the Internet and World Wide Web and transfer this synthesis to other users along with metadata, utilizing server-based software.

Whereas other web technology has involved grouping of multiple sites based on content relevancy such that a list of related sites may be presented to a user viewing a site, the present invention allows for concatenation: the contextual association between web accessible content that goes beyond and is in addition to relevancy to include user intention for the association. While relevancy may be considered, user intention includes contextual associations other than relevancy. These new associations may follow the pattern: user V associates W with X in Context Y and intends future users should do Z. For example, a possible concatenation would be: user A recommends that action B should be performed as it relates to article C in context D. In this case, it is the intention of user A that future users take Action B. Unlike previous systems, the association described in the present invention is explicitly subjective and relies on the identity of the user creating the association for credibility. For any given association the system presents the identity of the user who created an association, the intent behind the association, and a context for the association that indicates how the pieces of web accessible content relate to each other.

In addition, embodiments of the present invention may include systems that maintain linkages between content types, metadata about content, information about both the creators and consumers of associated content.

In addition, embodiments of the present invention may include server database and/or data repository systems that store data such as:
Relevant web accessible content that can be recommended by users or computers as relevant to a particular web page;
Content linkages;
Content context;
Metadata;
User data;
User identifying data;
User messages;
User intentions;
User rankings of information that can be used to sort information relevancy;
Records of the number and kind of actions taken by users who have accessed the concatenations created with the invention and taken further action; and
Indexes and relevancy statistics that identify and rate correlations made by users between existing web pages and information in the database.

In addition, embodiments of the present invention may include methods and systems of connecting to and transferring data to and from server database systems that are accessible through Internet and mobile clients through a variety of interfaces.

In addition, embodiments of the present invention may include methods and systems to create a new URL or tiny URL that references, and allows display of, synthesized content.

In addition, embodiments of the present invention may include methods and systems to allow users or computers to share the URL that refers to the concatenation together with a message with their network of friends and colleagues by utilizing existing social networks.

In addition, embodiments of the present invention may include methods and systems to allow users or computers to chose or alter the context that provides the conceptual frame-of-reference for the concatenated web accessible content.

In addition, embodiments of the present invention may include methods and systems to allow users to select and describe their intent for a given content concatenation.

In addition, embodiments of the present invention may include methods and systems to allow users or computers to display different contexts for the concatenated web accessible content.

In addition, embodiments of the present invention may include methods and systems to allow users or computers to display different content concatenations based on a user or computer chosen context.

In addition, embodiments of the present invention may include methods and systems such that users receiving URLs or tiny URLs created by the invention may view the concatenated information through the display of both the original data and the new data on their computers or mobile devices along with metadata about the articles and originating user.

In addition, embodiments of the invention may legitimize this concatenation by showing the sending user's ID and photo, if available, in addition to the concatenated information and original web page.

In addition, embodiments of the invention include a distribution method of and system whereby a plurality of web accessible content is assigned a new URL and/or tiny URL.

In addition, embodiments of the invention include a method and system of presentation as a graphical user interface that places the new information outside the perimeter of the existing page and does not cover or obstruct the original page.

In addition, particular embodiments of the invention include a program that users call from their computer or mobile device via a bookmarklet (a URL calling button that can be placed in a browser toolbar) to add new web accessible content to an existing website.

In addition, particular embodiments of the invention include a method and system for providing content recommendations relevant to web accessible content through natural language processing, collaborative filtering, content based recommendations or other systems for making recommendations. These recommendations may be formed into a list and stored in a database system that is available to users.

Uses of such a method and system that would allow concatenation and sharing of web content and associated metadata in a format that does not require unique client software (beyond a web browser) includes inspiring users to take and share social action opportunities, such as a volunteer or donation opportunities, that are perceived by other users to relate to a news article. The user who wants to promote the content relationship could use such a method and system to link an action to a news item, and generate a tiny URL encoding the relationship and metadata, such that the new tiny URL can be disseminated through email, TWITTER, FACEBOOK or other social networks. Users who click on the tiny URL will be taken to a web page where they will see the source content, as well as an information bar at the top of the web page that includes the related content, the user who created the relationship, and other users who have acted on this relationship thus giving the relationship legitimacy. In the example where this method and system are used to promote a cause or an action relating to a news article, the interface can guide other users to follow this course of action through prompts in the interface, and show the user a list of other people whom they may know who have performed the same action.

System and methods for concatenating web accessible content may include at least one server and one or more databases in communication with the at least one server. Systems and methods may receive a plurality of URLs wherein each of the plurality of the URLs is related to a distinct item of web accessible content; receive user data; receiving user identifying data; receive metadata; receiving a user message; receive at least one user intention by which URL concatenations may be made, wherein the at least one user intention is a description of a desired action to be taken by future users; and receive at least one context by which URL concatenations may be made, wherein the at least one context is a conceptual frame-of-reference for possible concatenations between the web accessible content. Systems and methods may concatenate the plurality of URLs, the user data, the user identifying data, the metadata, and the at least one user intention within the at least one context to create concatenated content; create one or more new URLs for the concatenated content; store the concatenated content or one or more new URLs in the one or more databases; storing the user message in the one or more databases; and outputting the one or more new URLs together with the user message.

Systems and methods may include displaying the metadata related to the concatenated content. One of the plurality of URLs may be a URL of a webpage the user is currently browsing. The plurality of URLs, the user data, the user identifying data, and metadata may be chosen by a user, another computer or a recommendation system. The one or more new URLs may be distributed by one or more of email, social networking, text message, and verbal output over telephone communication channels. Computer sorted relevant information may be presented to the user as a list from an existing database and the user can choose relevant information from the sorted list. The one or more new URLs may be tiny URLs. The concatenated content may be used to provide metrics regarding user actions and interests. The one or more new URLs may facilitate action, by a receiving user, related to the at least one context and to the at least one user intention. The one or more new URLs may each allow the display of a new webpage that comprises the web accessible content, the metadata, the concatenated content, the user message, the user intention, the user identifying data, the user data in a browser or other system that can display web accessible content. The one or more new URLs may each allow the transfer of the web accessible content, the metadata, the concatenated content, and the user data to other computers.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention.

FIG. 1 is an exemplary flow chart illustrating the system for combining and sharing information in a networked computing environment, according to one embodiment.

FIG. 2 is a block diagram that illustrates how content is concatenated together with meta-data and served, according to one embodiment.

FIG. 3 is a block diagram that illustrates how a user may view concatenated content in manner, according to one embodiment.

FIG. 4 is a block diagram that illustrates the data extracted from the web page the user is viewing and also from the user's profile in a manner, according to one embodiment.

FIG. 5 is a block diagram that illustrates the use of a data processing device for making content recommendations, according to one embodiment.

FIG. 6 is a flowchart that illustrates the operations of the recommendation system to recommend relevant web accessible content to users and store those recommendations in the database system and data repository, according to one embodiment.

FIG. 7 is a block diagram that illustrates an exemplary data processing device, according to one embodiment.

FIG. 8 is a block diagram that illustrates an exemplary networked environment, according to one embodiment.

FIG. 9 is a flowchart that illustrates the flow of data between client and server systems, according to one embodiment.

FIG. 10 is a flowchart that illustrates the operations for the display of a web page along with relevant additional information, according to one embodiment.

FIG. 11 is a flowchart that illustrates operations for accessing concatenated information from a hyperlink, according to one embodiment.

FIG. 12 is a flowchart that illustrates operations for promoting a particular action opportunity along with web accessible content, according to one embodiment.

FIG. 13 is a flowchart that illustrates operations for a taking a particular action opportunity, according to one embodiment.

FIGS. 14-16 are diagrams of an exemplary user interface for promoting a web page and addition relevant information, according to one embodiment.

FIG. 17 is a diagram of an exemplary user interface for publishing cause related content that leads to promotions and actions, according to one embodiment.

FIG. 18 is a diagram of an exemplary user interface for publishing cause related content that leads to promotions and actions, according to one embodiment.

FIGS. 19-20 are diagrams of exemplary user interface client profile pages that lead to promotions and actions, according to one embodiment.

FIG. 21 is a diagram of an exemplary user interface action page that leads to promotions and actions, according to one embodiment.

FIG. 22 is a diagram of an exemplary user interface action-listing page that leads to promotions and actions, according to one embodiment.

### DETAILED DESCRIPTION OF THE EMBODIMENTS

Systems and methods are described for concatenating and transferring information between networked computers and mobile devices. The examples described herein relate to drawing figures for illustrative purposes only. The systems and methods described herein may be used for many different industries, including, for example, philanthropy, academia, marketing, advertising, health care, and many others. Embodiments of the present invention may include use in media websites, use in information bars, nonprofit web sites, corporate CSR websites, healthcare sites, etc.

Although not required, the systems and methods are described in the general context of computer program instructions executed by one or more computing devices. Computing devices typically include one or more processors coupled to data storage for computer program modules and data. Well known processes, procedures, algorithms, and protocols have not been described in detail as anyone with ordinary skill in the art should be able to build the current invention on a number of possible platforms once apprised of the methods and systems shown herein. Such program modules generally include computer program instructions such as routines, programs, objects, components, etc., for execution by at least one processor to perform particular tasks, utilize data, data structures, and/or implement particular abstract data types. While the systems, methods, and apparatus are described in the foregoing context, acts and operations described hereinafter may also be implemented in hardware.

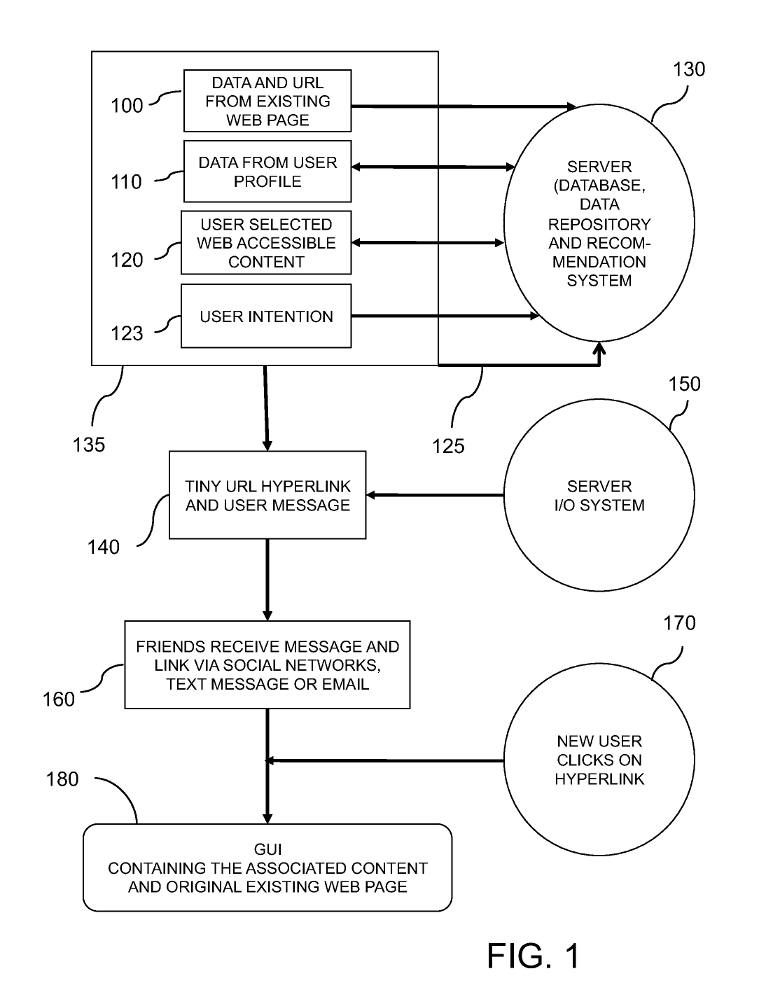

FIG. 1 shows an exemplary system for concatenating and sharing information according to one embodiment of the current invention. In this exemplary implementation, after viewing a web page and choosing to promote it, thus utilizing an embodiment of the current invention, a user selects web accessible content 120 and declares an intention 123 to be combined with data from an existing web page 100, designated by a URL. In certain embodiments, the URL may be for the webpage the user is currently browsing. The web page is associated with the web accessible content and data about the user 110 including user identification and is given a reference index in the server database 130 and data regarding the user's choices are updated in the data repository 130. An index for the entire concatenation is stored in the data repository and the database is updated to reflect the new concatenation 125. This concatenation from the user 135 may then be given a unique URL or tiny URL 140 by the input/output system 150 and together with a message be sent to individuals via email or the user's social networks. The entirety of the data regarding the original web page, user profile and user selected web accessible content are given a single index in a relational database, i.e., they are grouped in system 125

Upon receiving such a message including a URL or tiny URL 160, new users may click the URL or tiny URL 170 which may open a new browser window or browser tab containing the entire original web page along with the associated information and metadata in an annotation that may reside outside the boundaries of the web page or in a layer above the web page 180.

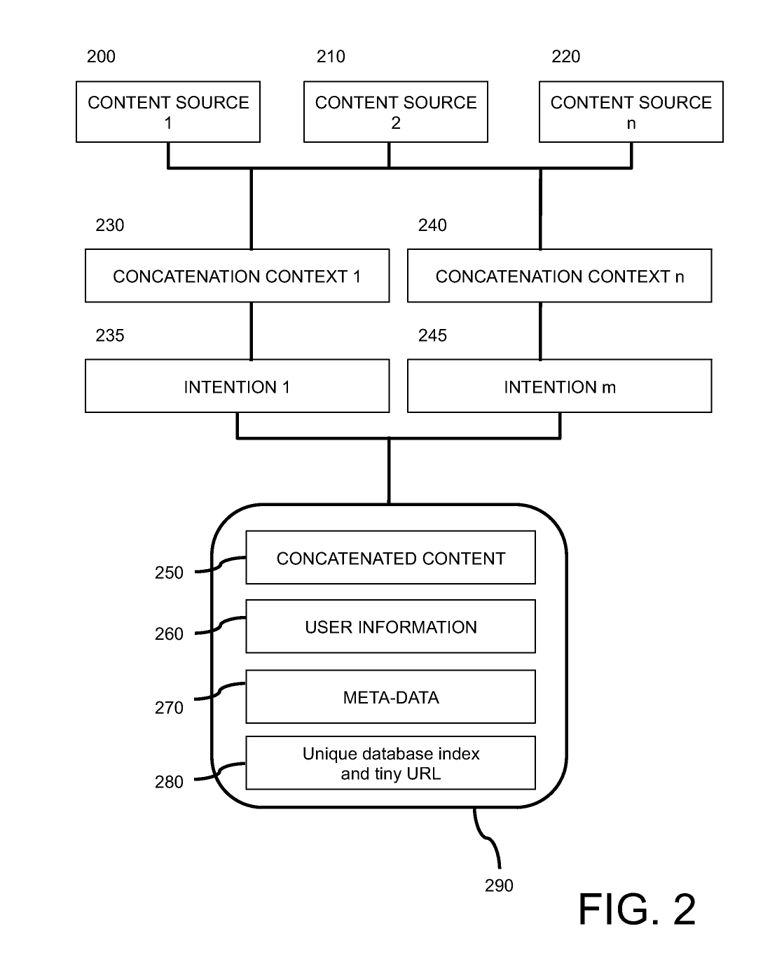

FIG. 2 illustrates how a plurality of content sources, consisting of web accessible content, may be concatenated by the present invention. Users of the system are able to create content associations through a web interface that allows for the storage of other web page URLs, contexts for concatenation, user intention for the concatenation, written comments, user data, user identifying data, metadata, file attachments or other data on a server, and a URL referencing the concatenations. Content sources 200, 210, 220 are referenced by URLs that are stored and indexed in databases in the preferred embodiment of the current invention along with metadata about the content source, author, publication, date, classification, and other information 290. Content sources are presented to the user through visual interfaces that allow the user to select content and potentially relate content.

A visual interface presents the user with contexts 230, 240 by which content could be related. Context may include descriptions of how different content or information is related to one another. Context may be user suggested, computer suggested, or otherwise. A user may be given a list of sample contexts, or may create a new context. One example of a context is social responsibility whereby content referencing a volunteer opportunity or donation would be presented to users and could be related to a content source (for example content source 1:a news article and content source 2:a volunteer action and context 1:social responsibility). The user could potentially select from multiple context types for any content sources 240. Context types are stored in a database and retrieved by the system for display or selection by the user. In addition, users can potentially filter content results either in real time or through settings in their user profile (for example only viewing social actions). The system allows for any number of content types to be concatenated with any number of contexts.

In addition, a visual interface may allow the user to determine and describe the intentions by which content is related 235, 245. Intention may be user suggested, computer suggested or otherwise. A user may be given a list of sample intentions, or may create a new intention. One example of an intention may be the desire for future users who access the output of the current invention to make a particular donation. Intention types may be stored in a database and retrieved by the system for display or selection by the user.

A variety of user interfaces on a variety of platforms may be used to render the source content, concatenated content, user data and metadata, as the system is server-based. In one embodiment the user interface may be a web bar overlaid over the source content in a web browser. In another embodiment the interface may be a toolbar or a menu rendered on a mobile device such as an iPhone or an Android phone. In any of the embodiments, stored content relationships can be represented to users in such a way as to guide action and to alert users both to the concatenation between content and the intent of the user that created the relationship. When a user has completed the actions relating content and providing context for the concatenation through the user interface, the resulting relationship and all associated content annotations are stored in a database and referenced by a unique identifier 280 that is represented by a tiny URL 280 that users can click on to render the referenced content and content annotations in a graphical user interface or other user interface. The resulting tiny URL references the entire synthesized content box 290.

In addition to providing users with a way to relate content and present the concatenation to other users, the current invention can be used to track what other users have done with the resulting concatenation. For instance, the system can track the number of visitors or the identity of users when registered with the system who have clicked on the URL, have viewed related content, or have concluded some form of activity intended through the concatenation (such as donating to a cause represented by content linked to a news article, or volunteering for a cause represented by content linked to a news article).

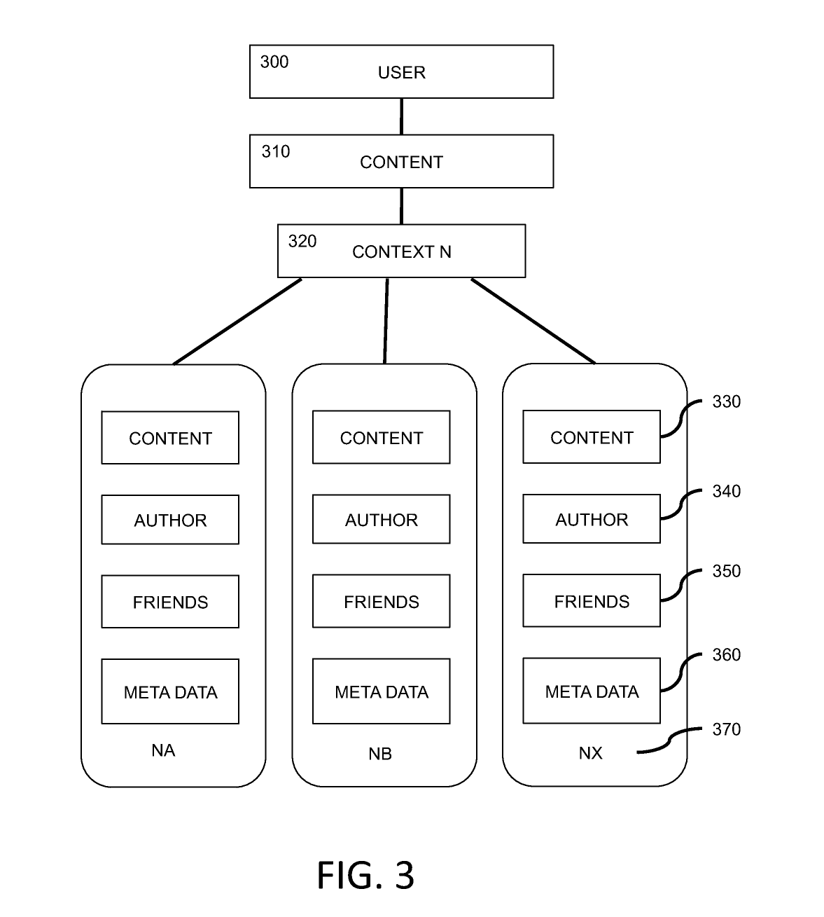

FIG. 3 illustrates a variety of possible content associations that a user may view consisting of synthesized content resulting from use of an embodiment of the current invention. A user 300 who views a web page 310 referenced by a URL created with the current invention will see synthesized content 310 and 330 as well as information about the author of the synthesis 340 and the context or contexts 320 of the of the content linkages. The system can maintain and display information about other related content from previous uses of the invention by other users. The system can also display alternate contexts for the source content suggested by the same or other authors 320 and alternate content for the same context suggested by the same or other authors as in 330 NA or 330 NX. Additionally, for contexts that involve a user action, the system can display information about other users who have completed the action suggested by the context content relationship 350. The system can display actions by other users known to the viewer through person-to-person relationships established through others systems (i.e. social networks) or users directly identified by the viewer as personal contacts or persons of interest. Metadata can be presented to the viewer to provide further information about the source article or associated articles such as popularity, page views, comments, number of concatenated articles and other information 360.

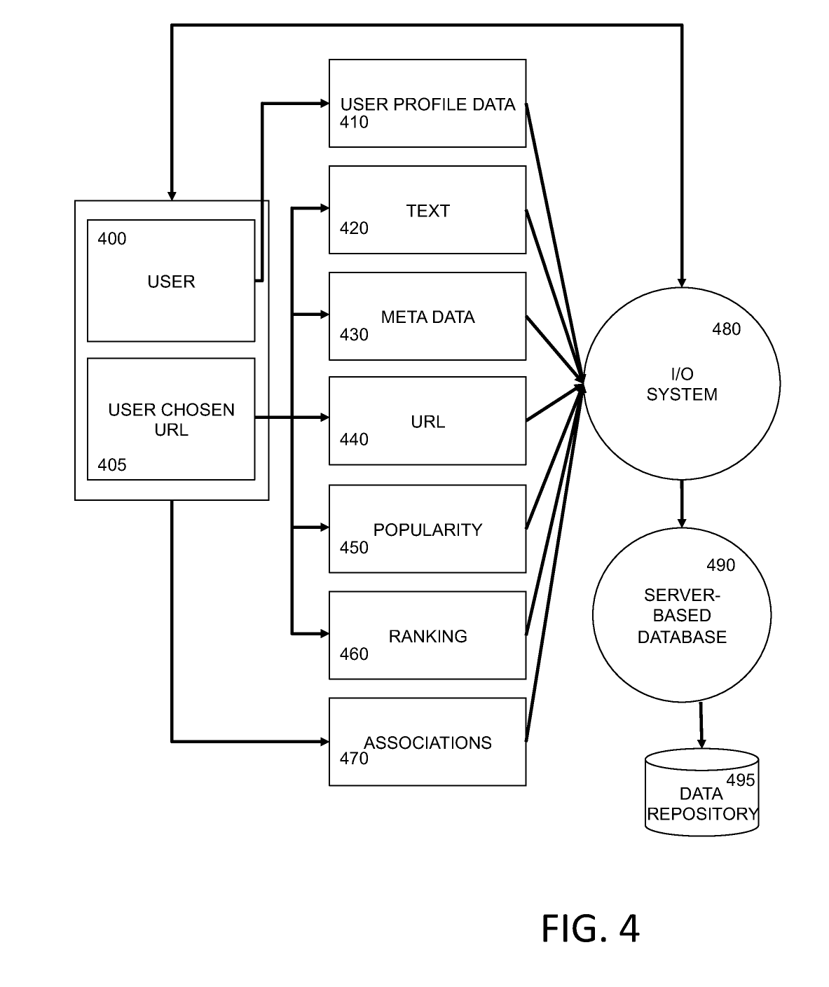

FIG. 4 illustrates the data and metadata an embodiment of the current invention parses from existing web sites and user profiles in the case when a known user 400 selects a web page 405 within a preferred embodiment of the invention. A known user's profile data, which may include information from their preferred social networks (i.e. FACEBOOK, LINKEDIN, etc.) 410, text inputted by the user 420, meta data 430, URL 440, popularity 450, ranking 460 and both content and context associations 470 are parsed and stored via the I/O system 480 in the server-based database repository 495 and the database 490 is updated to reflect the new information. This information allows the system to both provide new contexts for information concatenation and new relevant web accessible content and actions throughout the system database.

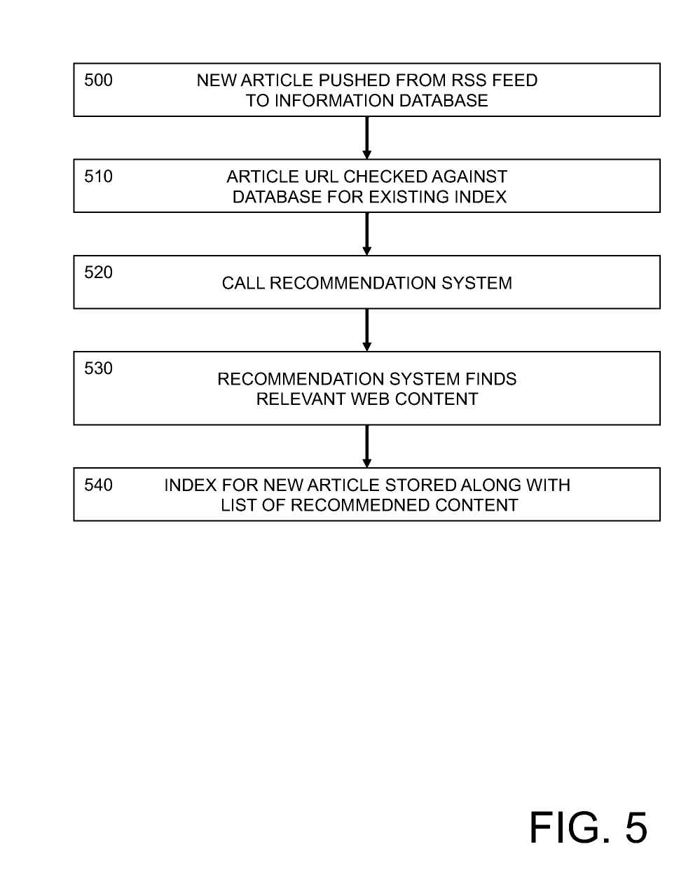

FIG. 5 illustrates content consumption and processing by use of an optional recommendation system according to an embodiment of the current invention to find relevant web content for potential concatenation with new web content that a user is viewing. New articles (web accessible content) are preferably received by the input/output module and parsed 500. They are then checked against the existing system database for possible match 510. If no match is found, the I/O module then calls the recommendation system 520, which then further parses the content of the received web page and finds relevant web content from a data repository or other source 530. The index for the recommended content is then stored along with the reference URL for the article so that future calls for recommendations for the referenced URL will be efficient 540.

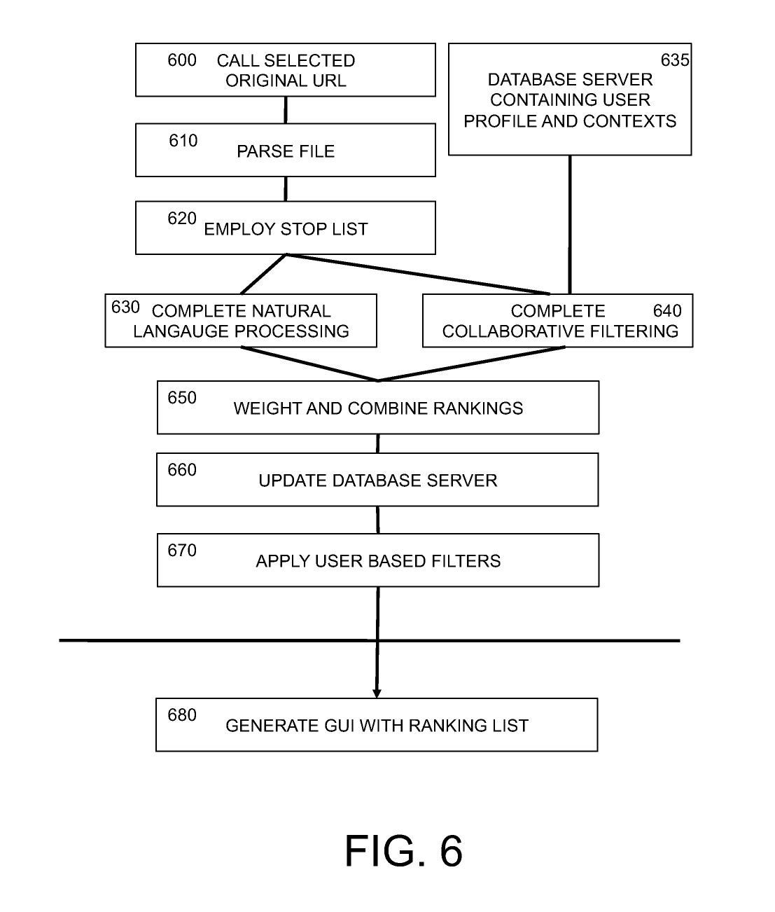

Embodiments of the present invention may include a recommendation system of the type illustrated in FIG. 6. The recommendation system may be used to facilitate the concatenation of web content to other web content. When a user utilizes an embodiment of the current invention to view an existing web page, the current invention may call the selected URL 600 and parse the content of the received file to select for content text (article titles, authors, dates of publication, article content, associated key words, abstracts or other relevant information) 610. The system then employees a stop list to remove words from the parsed text that are irrelevant to the recommendation system 620. The parsed and cleaned text is then processed by a natural language processing module 630 and separately by a collaborative filtering module 640. The natural language processing module compares the article content to content in the system database and determines relevancy. The collaborative filtering module compares the current user's profile and contexts 635 to previous users who have viewed the same or similar articles and may suggest other content based on the choices of these previous viewers through the application of a computer algorithm. The results from the natural language processing module and collaborative filtering module are weighted and combined to provide rankings for all possible associable content in the database system 650. The database is then updated with this new information 660. User preferences, for instance for volunteer content as opposed to donation content, may be applied in a preferred embodiment of the invention to filter the list of ranked content 670 prior to the display of the ranked list in a graphical user interface readable by a user 680.

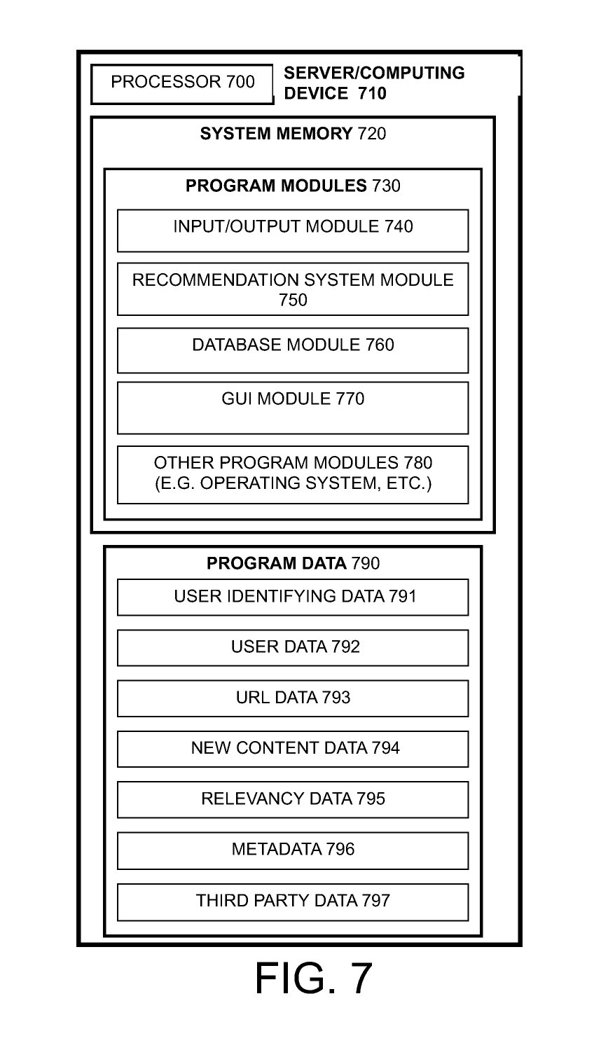

In an exemplary implementation, a server/computing device 710 includes at least one processor 700 coupled to a system memory 720, as shown in FIG. 7. System memory 720 includes computer program modules 730 and program data 780. In this implementation, program modules 730 may include input/output module 740, recommendation system module 750, database module 760, graphical or non-graphical user interface module 770 and other program modules 780 such as an operating system, device drivers, etc. Each program module 740 through 780 may include a respective set of computer-program instructions executable by processor(s) 700. This is one example of a set of program modules and other numbers and arrangements of program modules are contemplated as a function of the particular arbitrary design and/or architecture of server/computing device 710 and/or the system shown in FIG. 1. Additionally, although shown on a single server/computing device 710, the operations associated with respective computer-program instructions in the program modules 790 could be distributed across multiple computing devices. Program data 790 may include user identifying data 791 user data 792, URL data 793, new content data 794, relevancy data 795, meta data 796 and other program data 797 such as data input(s), third party data, and/or so on.

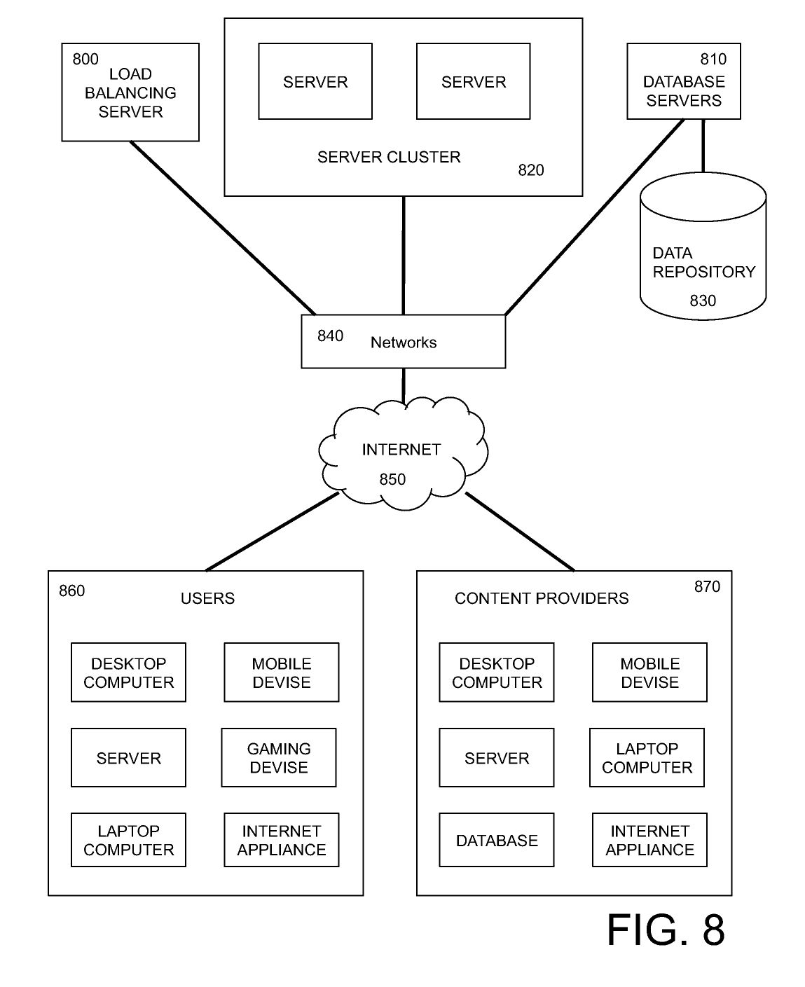

An example of an environment embodying the present invention is shown in FIG. 8 and includes multiple servers of the type outlined in FIG. 7 and includes server/computing device(s) 820 and may include a load balancing server 800, one or more database servers 810 and one or more data repositories 830 operatively coupled over an Ethernet network 840 to each other and to the Internet 850. Such networking environments are commonplace in offices, enterprise-wide computer networks, etc. Client computers, which may include at least one processor 860 represent a set of arbitrary computing devices executing application(s) that respectively send data inputs to server/computing devices 800, 810, 820 and/or receive data outputs from server/computing devices 800, 810, 820. Such computing devices include, for example desktop computers, server computers, laptop computers, mobile devices, gaming devices or Internet appliances. Content providers may also utilize desktop computers, servers, database servers, mobile devices, laptop computers or Internet appliances. Both content providers and users may be connected to the Internet by any combination of wireless networking, satellite networking, Ethernet, optical fiber, etc. In this implementation, the input data comprises, for example, data hierarchy, data files, user profile data, donation amounts, due dates, and/or so on, for web associated content concatenation utilizing an embodiment of the current invention as shown in FIG. 1. In one implementation, the data outputs include, for example, a volunteer opportunity or donation or the promotion of either of the previous concatenated with a message and other of a plurality of web accessible content. Embodiments of the present invention may also be used for collaborative projects with multiple users logging in and performing various operations on a project from various locations. For example, a nonprofit marketer, a member of the general public, a media provider might all be logged in from various locations.

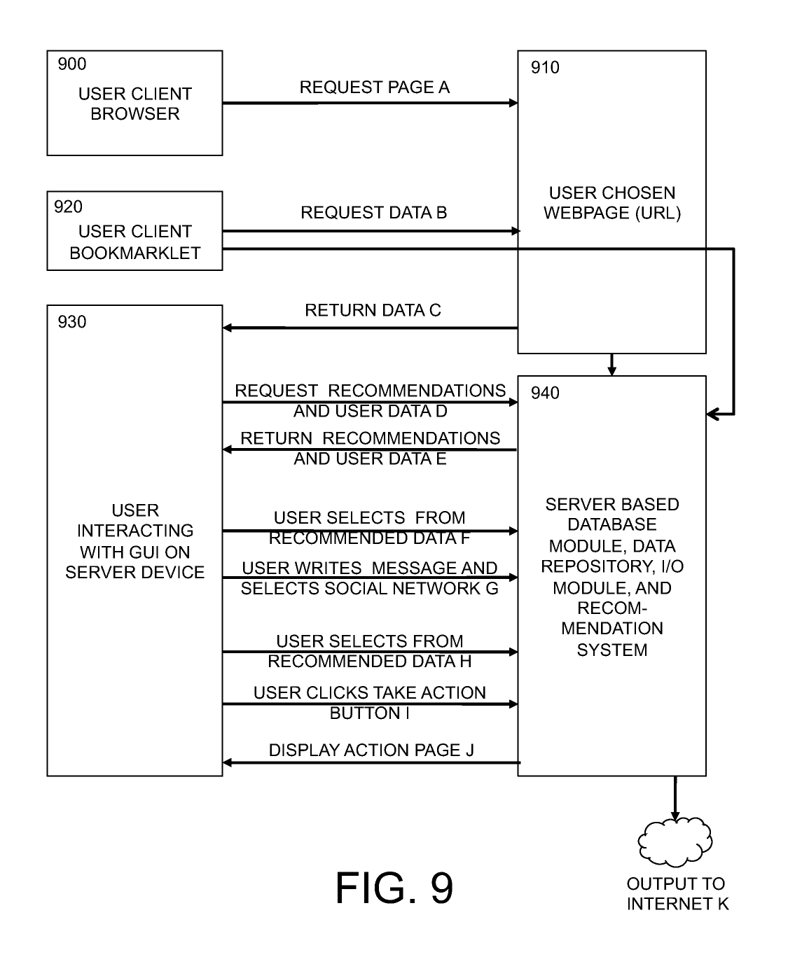

FIG. 9 illustrates typical data transfer in one of the preferred embodiment of the current invention utilizing a recommendation system. When a user first navigates to a web page, the user's browser 900 requests the html (A) from the server and html code referenced by the universal resource locator (URL). Upon deciding to concatenate the given web accessible content and forward it to friends (promote it) or to respond to a call for action such as, for instance, a volunteer opportunity or donation (take action), the user may instantiate an instance of the invention by clicking a bookmarklet that then requests data from the server of the user chosen webpage 910 (B) and calls the input/output module and database module 940. (A bookmarklet may be an applet, a small computer application, stored as the URL of a bookmark in a web browser or as a hyperlink on a web page.) This data from the user chosen webpage is then returned to a new browser window or tab where the page is again displayed together with a graphical user interface (GUI) 930, which is placed either outside the boundaries of the web page or layered on top of the web page. The GUI 930 then requests recommendations and user data from the database module and data repository 940. If the given web page has not been previously catalogued in the database, a new entry will be instantiated and the recommendation system will be called to produce recommendations of relevant web accessible content. The server-based modules 940 then return recommendations and user data (E) to the GUI. The user then has several options. The user may select recommended content from the list produced by the recommendation system (F) and write a message and choose to forward the message along with the original web page and newly selected content via any of their social networks (G). The server-based input/output module 940 then will assign the concatenated information a tiny URL and forward the message together with the tiny URL to the selected recipients (K). Alternatively, the user may choose to take action by selecting a particular action opportunity from the recommended list (H) and clicking the ‘Take Action’ button (I). This causes the server-based database module 940 to return information (J) from the data repository 940 to the GUI 930 for display of complete information about the action.

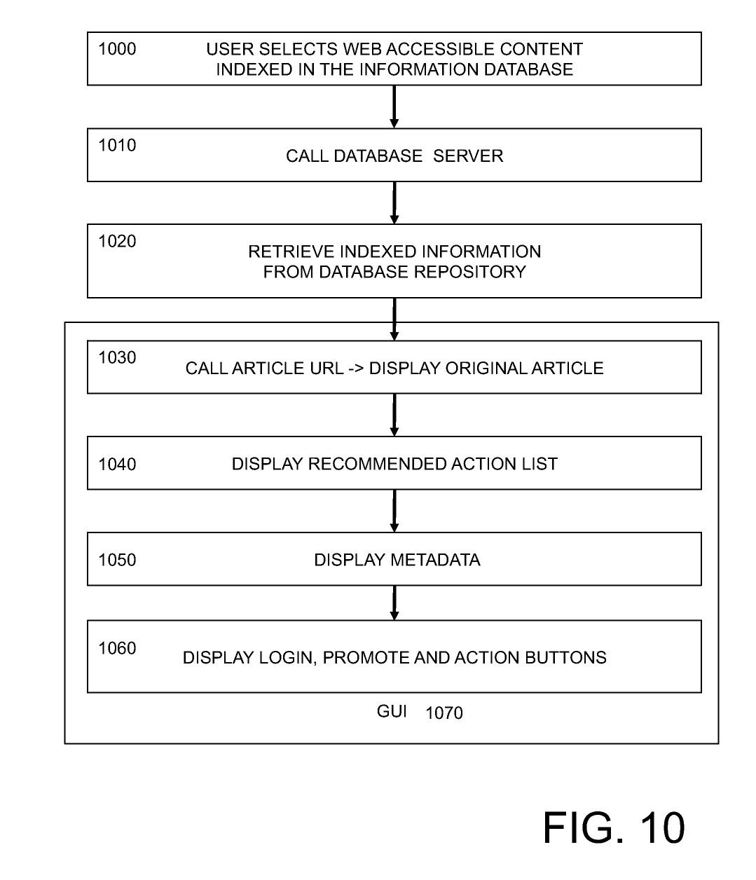

The current invention would be a useful addition to news or news aggregating web sites such that when a user selects a news article, they could also be apprised of relevant actions opportunities that relate to the news they are reading. FIG. 10 is a flowchart that illustrates the operations of an embodiment of the current invention in a particular case. FIG. 10 exemplifies the case where the news has already been indexed by and an embodiment of the invention's database module. In this case, when the user selects a news article on the news web site or news aggregation web site 1000 and potentially a context for determining the type of content to be provided, the database server is called 1010 and retrieves indexed information from the database repository 1020. This information may include a relevant list of web accessible content together with information about the user and metadata about the news article. The article 1030 is then displayed in the context of a GUI 1070, as also described in FIG. 7, that also includes a recommended action list 1040, metadata 1050 and login, promote and action buttons 1060.

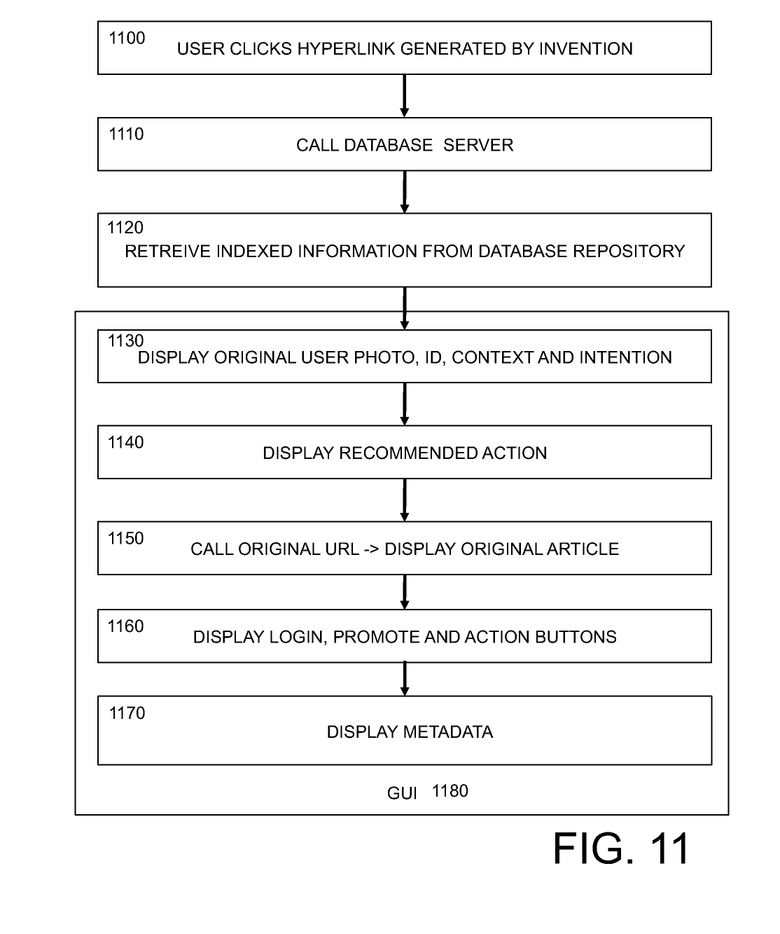

FIG. 11 illustrates an example of a case where an embodiment of the current invention may be used. It exemplifies the case where a user has been sent a message and tiny URL created by a previous user of the invention. When the user clicks on the tiny URL hyperlink 1100, the database server is called 1110 and retrieves indexed information from the database repository 1120. This information may include a relevant list of web accessible content, the chosen item of web accessible content along with information about the user and metadata about the news article and concatenated content. The article 1150 is then displayed in the context of a GUI 1180 as described above that also includes the previous user's photo, ID, context and intention 1130, if available, the previous user's recommended action 1140, login, promote and action buttons 1160 and other metadata 1170.

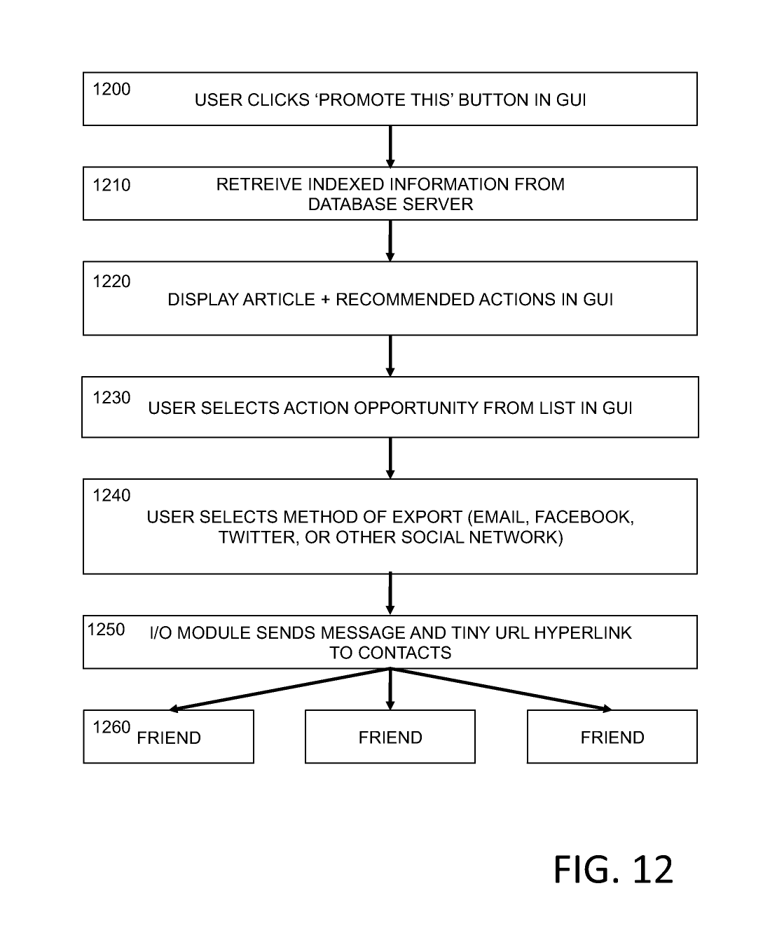

FIG. 12 illustrates a flowchart for promoting a particular action opportunity or piece of web content by clicking ‘Promote This’ button according to embodiments of the current invention. The ‘Promote This’ button could be used by media providers anywhere a share button might be utilized online. In the current embodiment, the user clicks the ‘promote this’ button 1200, which causes the database server to retrieve indexed information (recommended content, relevant user's friends, metadata, etc.) from the data repository 1210 and forward it to a GUI 1220 for display along with the original article as exemplified in FIG. 10. The user may then select a particular action opportunity from a list of possible web accessible content in the GUI 1230 and select a method to export the concatenated action opportunity or other web accessible content and article along with associated metadata to friends or colleagues 1240. The input/output module 740 then will send the message, tiny URL hyperlink to the selected user contacts 1250, 1260.

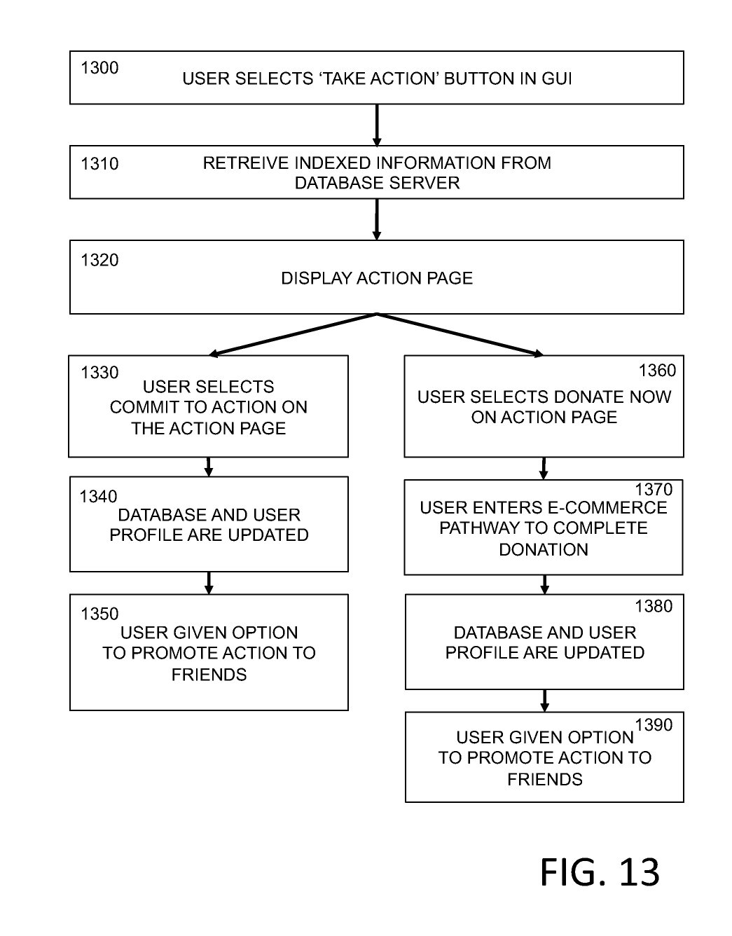

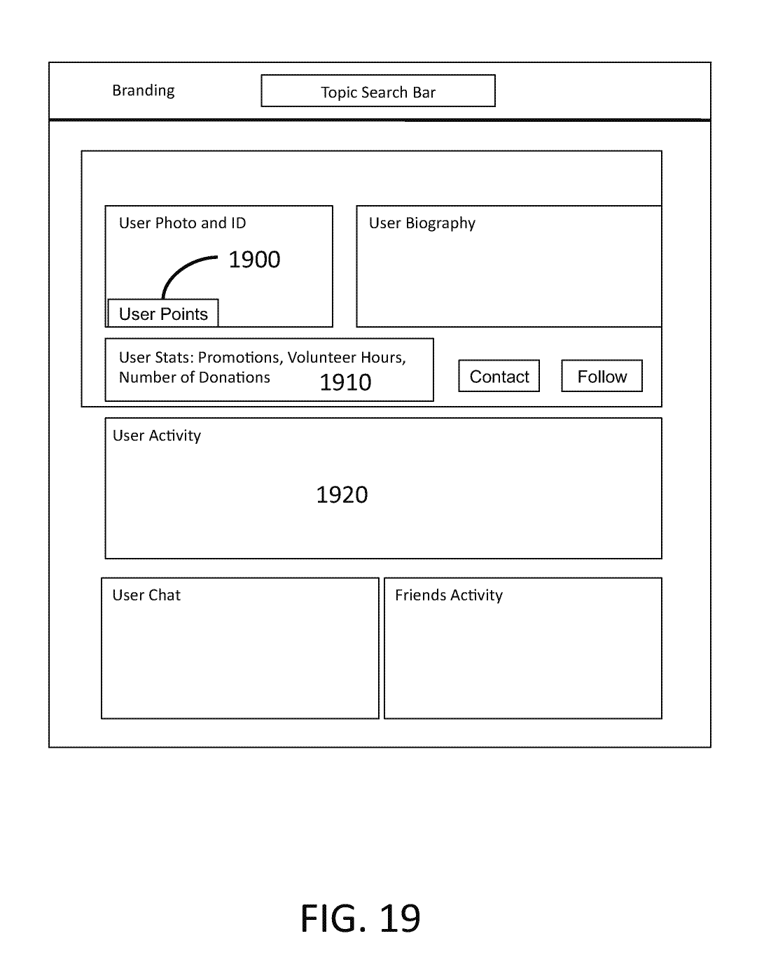

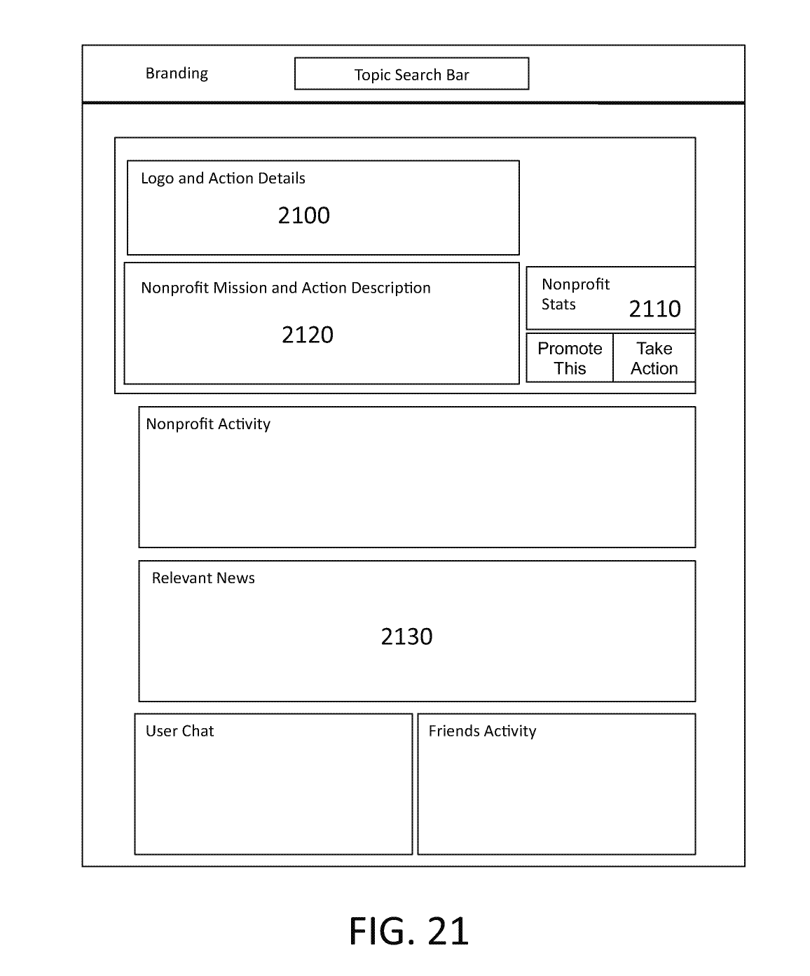

FIG. 13 illustrates a flowchart for taking action on a particular action opportunity or piece of web content by clicking ‘Take Action’ button according to a preferred embodiment of the current invention. When a user clicks the ‘Take Action’ button in the GUI 1300, the selected action from the GUI, which may have been selected by another user, a computer based recommendation system or other method\ is retrieved from the data repository via an index in the database server 1310 and displayed as an action page 1320 where relevant details about the action are presented along with metrics and other metadata about the action FIG. 21. The user may choose to commit to a volunteer action 1330 or complete a donation 1360. If the user selects to commit to a particular action, the user's database entry and profile (FIG. 19) are updated 1340 and the user is given the option to promote the action to his or her contacts 1350. If the action opportunity is a donation and the user chooses to donate 1360, the user enters an e-commerce pathway to complete the donation 1370 and the user's database entry and profile (FIG. 19) are updated 1380 and the user is given the option to promote the action to his or her contacts 1390. Thus we see an embodiment of the current invention in the social action space.

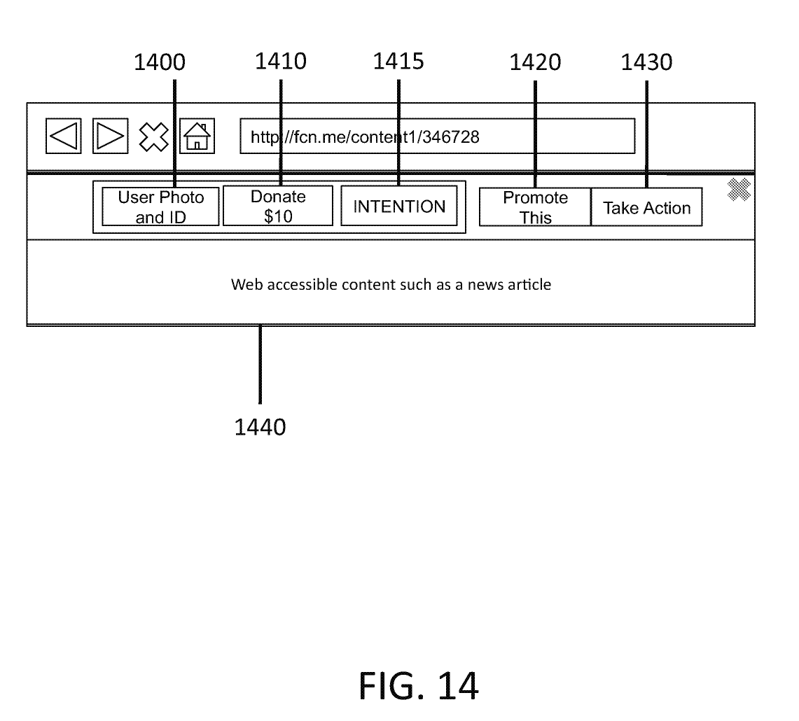

FIG. 14 illustrates an example screenshot of a preferred embodiment of a GUI, called an information bar, in use with the current invention. This screen shot illustrates an example of the GUI display as described in FIG. 11 (GUI 1180) where the originating user who concatenated the web accessible content is shown in a photo and ID 1400. In this illustrative case, the originating user is promoting an article 1440, a donation opportunity 1410 as a solution to the problem the user perceived in the article, and a descriptive sentence calling for action of the type intended by the user 1415. The ‘Promote This’ button 1420 and ‘Take Action’ buttons 1430 can be used by the current user, who received, and clicked on, a hyperlink from the originating user, to take action or promote the current concatenation or create and promote a new concatenation or make the donation suggested by the originating user or another action.

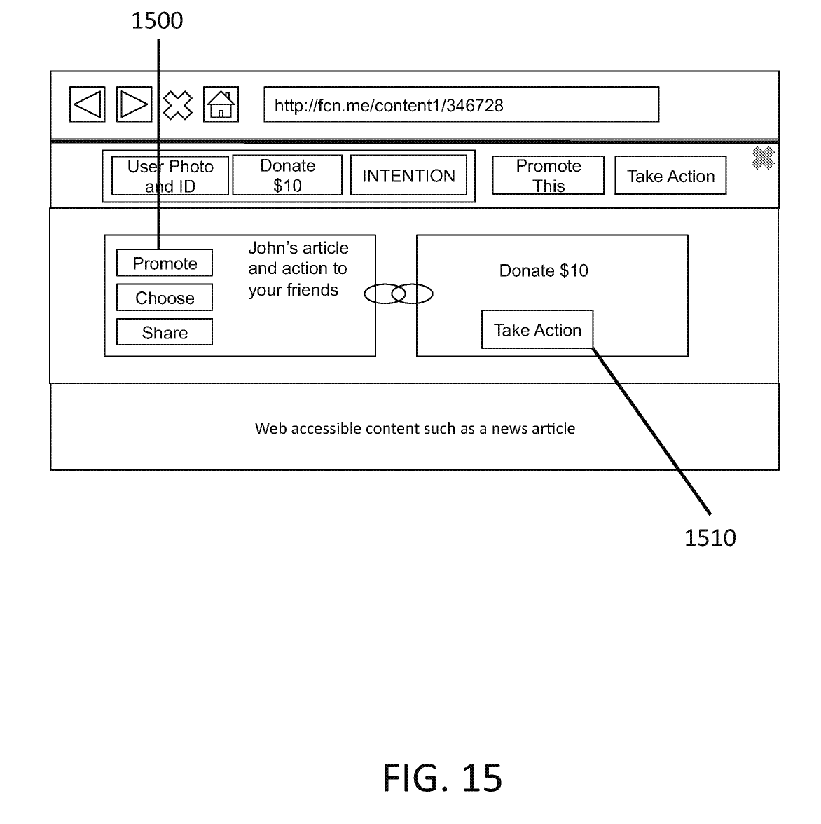

FIG. 15 illustrates an example screenshot of a preferred embodiment of a GUI, called an information bar, in use with the current invention. This screen shot illustrates an example of the GUI display as described in FIG. 11 (GUI 1180) after the current user has chosen to promote the concatenated new-action pairing as suggested by the originating user and has clicked the ‘Promote This’ button. The user sees more detail about the proposed action opportunity linked to the promotion box where the promote button 1500 is highlighted. The user may take action by clicking the ‘Take Action’ button 1510.

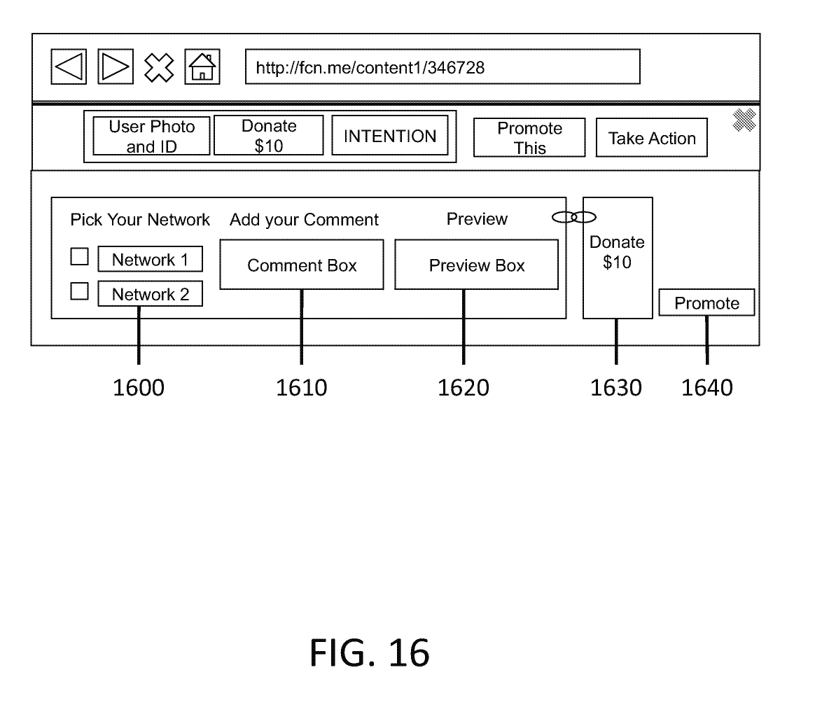

FIG. 16 illustrates an example screenshot of a preferred embodiment of a GUI, called an information bar, in use with the current invention. This screen shot illustrates an example of the GUI display as described in FIG. 11 (GUI 1180) after the current user has chosen to promote the concatenated new-action pairing as suggested by the originating user and clicked the Promote button in FIG. 15, 1510. The user now has the opportunity to pick a social network through which to promote the pairing 1600, add a message 1610 and preview the message 1620 while the proposed action opportunity 1630 is confirmed to be the linked action by the visual chain link to the message box. The user can complete the promotion by clicking the promote button 1640.

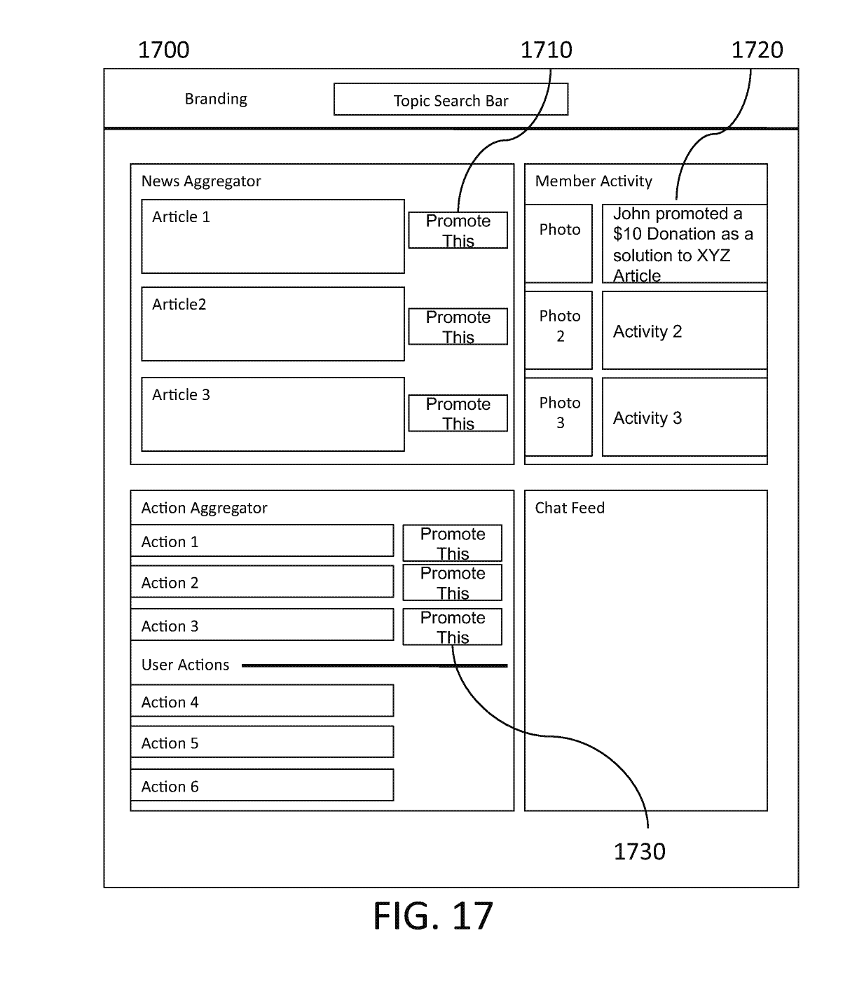

FIG. 17 illustrates an example screenshot of a preferred embodiment of a GUI, called a topic page, in use with the current invention. This screenshot exemplifies the possibilities for the use of the invention in multiple contexts. In the upper left quadrant, users can read articles related to a particular topic and choose to promote the article concatenated with action opportunities 1710. In addition, an embodiment of the current invention could provide metrics regarding user promotion and action statistics as well as general activity as shown in 1720 where a particular user is noted for having promoted a particular action opportunity as a solution to a particular article. In this particular example, action opportunities themselves can be inspiration for promotion. When a user clicks a promote button 1730 next to a particular action, an embodiment of the current invention could propose relevant news articles or other web accessible content for concatenation with the action and facilitate the pairing and propagation of the concatenated information as described in FIG. 1.

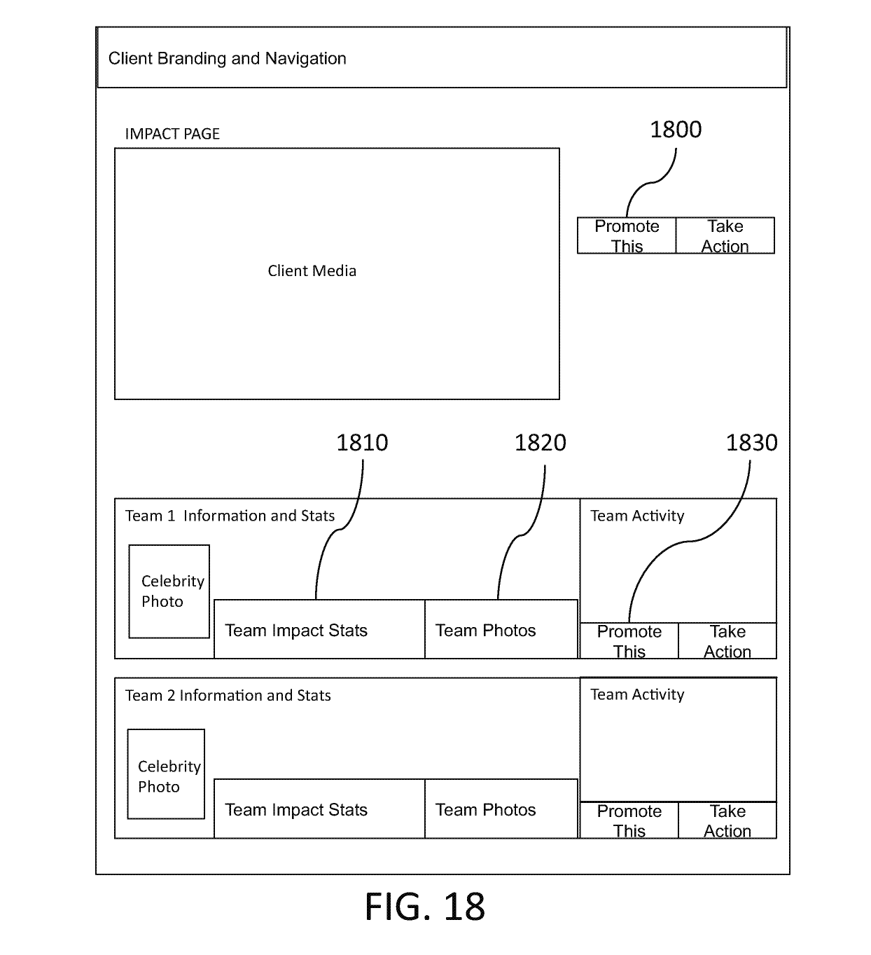

FIG. 18 illustrates an example screenshot of a preferred embodiment of a GUI, called an impact page that utilizes the current invention. This screenshot exemplifies possibilities for the use of the invention in media contexts. Promote buttons are associated with media content 1800 and headlines relevant to a particular celebrities cause 1830. In addition, users who are active participants are displayed on such a page 1820 through the ranking of profile information derived from the invention's database. Additionally, metrics 1810 are available that show information about the number of volunteer hours or number of donations made by users that follow a particular user, in this case a celebrity.

FIG. 19 illustrates an example screenshot of a preferred embodiment of a GUI, called a profile page that utilizes the current invention. This screenshot of a user profile exemplifies possibilities for the use of the invention in social media contexts. Users can garner points for promoting or taking action 1900. Metrics 1910 are available that show information about the number of volunteer hours or number of donations made both by a user and by the users to whom the user promoted concatenated information pairings utilizing an embodiment of the current invention. A user's activity can be tracked and displayed 1920, drawing from the database module 760.

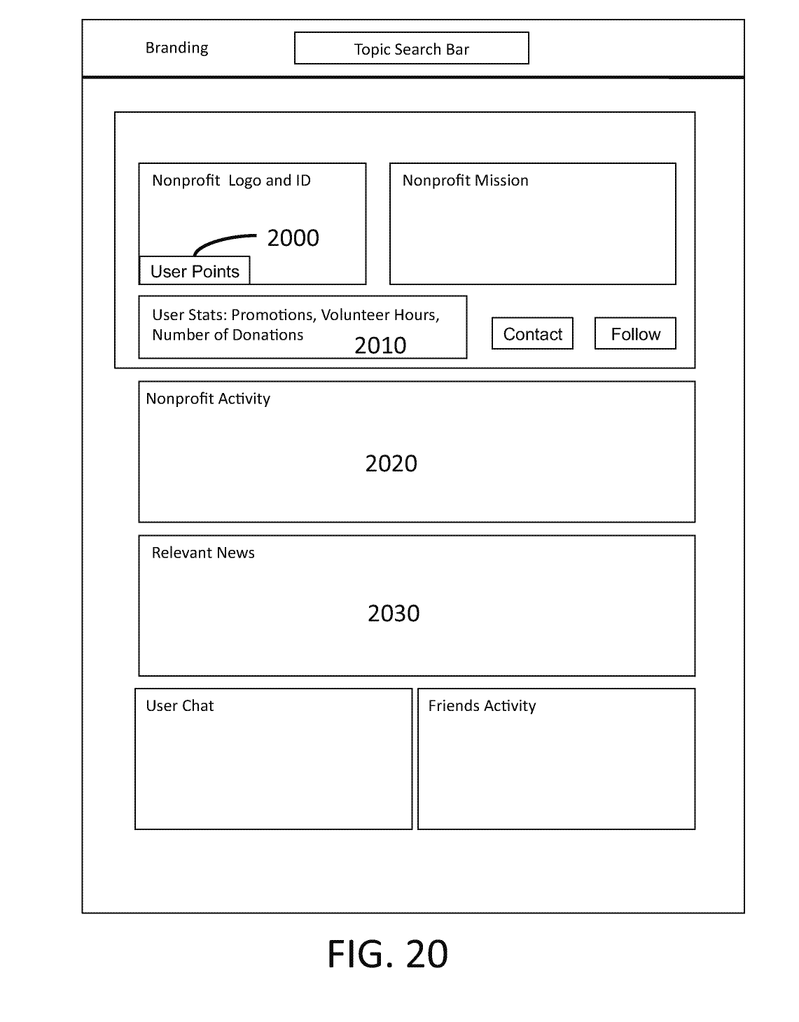

FIG. 20 illustrates an example screenshot of a preferred embodiment of a GUI, called a nonprofit profile page that utilizes the current invention. This screenshot of a nonprofit profile exemplifies possibilities for the use of the invention in social media contexts. Nonprofits can garner points for promoting or taking action 2000. Metrics 2010 are available that show information about the number of volunteer hours or number of donations made both by a nonprofit and by the users to whom the nonprofit promoted concatenated information pairings utilizing an embodiment of the current invention. News and other web accessible content can be aggregated that is relevant to a particular nonprofits mission 2030 and a nonprofits activity can be tracked and displayed 2020, drawing from the database 760.

FIG. 21 illustrates an example screenshot of a preferred embodiment of a GUI, called an action page, in use with the current invention. This screenshot of an action exemplifies possibilities for the use of the invention in multiple contexts. Details about the action are displayed 2100. Metrics 2110 are available that show information about the number of volunteer hours or number of donations made by users who have taken a particular action. The sponsoring organization's mission and a detailed action description are displayed 2120. News and other web accessible content can be aggregated that is relevant to a particular action's content and its sponsoring nonprofit's mission 2130.

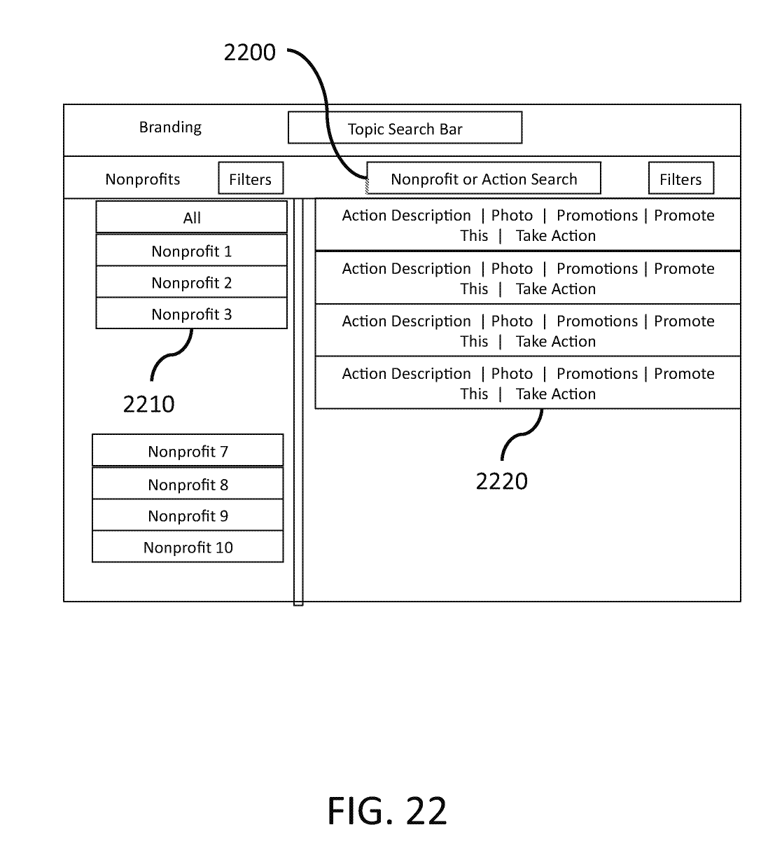

FIG. 22 illustrates an example screenshot of a preferred embodiment of a GUI, called an action-listing page, in use with the current invention. This screenshot of the action-listing page exemplifies possibilities for the use of the invention in multiple contexts. Users can search for actions of interest by keyword 2200, by nonprofit 2210 and see a description and metrics for a particular action 2220. This is a public display of web accessible content stored in one or more of the server databases that are part of the current invention and present opportunities for promoting actions utilizing the current invention.

Embodiments of the present invention may have various potential applications. Applications include, but are not limited to:

Bookmarklet: A user may connect web accessible content to an article they are reading then forward this concatenated information to friends and colleagues in the form of a message containing a hyperlink. Upon clicking the hyperlink, the second generation user may be returned to a browser window designated by a new URL that renders both the original article and instructions regarding the donation or volunteer service in an area at the top of the web page.

Website: A user may be able to connect articles, blogs, photos or videos with volunteer or donation opportunities that are selected by a recommendation system or by the user and forward them to friends and colleagues.

Web Bar: A second generation user who has clicked on a link from another user can utilize a web bar GUI to continue the trend of concatenation by forwarding the same concatenation on to his or her friends and colleagues or can choose another action opportunity to connect to this article presented by the initial user.

Mobile Application: A simple mobile application may recommend daily relevant news and action opportunities that an individual could use to pass on as a concatenation identified with a tiny URL to contacts in their social network. The user would then be able to track their impact, i.e., the number of donations and hours of volunteer work that their promotions caused.

Widget: A widget may be used to supply the current invention's output on a webpage.

Share Button: A piece of code may be employed by clients, where the code creates a typical share button as found on most media sites that typically allow users to share articles. In this case, the share button, called a ‘Promote This’ button may call the invention database and presents the user with relevant opportunities for action that the user can then concatenate with the existing web page and share with their social network.

Cause Marketing: A cause marketer may use tools of the present invention (Website, Web Bar and Mobile App) to market their particular cause by setting preferences that would allow them to see only relevant news and conversations relating to their cause along with action opportunities that support their organization/cause. Users can then pass along these news-action concatenations to contacts in their social networks and track their impact.

Health Care: A healthcare stakeholder may use the invention to connect relevant academic or industry papers to existing media and forward links to this concatenation to other interested stakeholders.

Advertising: An advertising agency may use the invention to connect relevant advertisement and promotion opportunities to existing media and forward links to this concatenation to interested parties.

Academia: University administration, staff or professors may use the invention to connect academic articles and discoveries with existing media articles providing deeper context, meaningful critique or rich support of such articles.

Unless specifically stated otherwise, as apparent from the following discussions, it is appreciated that throughout the specification discussions utilizing terms such as “process”, “processing”, “computing”, “calculating”, “determining” or the like, refer to the indication and/or processes of a computer or computing system, or similar electronic computing device, that manipulate and/or transform data represented as physical, such as electronic, quantities into other data similarly represented as physical quantities.

Several terms, although commonly used, have specific meanings in relation to the current invention so are defined only for the purpose of clarity and are not meant to limit the invention, as follows:

“user” may be either a human being or a computer system.

“user data” may be defined for the current invention as descriptive, characterizing, but not user identifying data. Such data may include user profile information such as a personal biography, topics of interest, actions taken, comments made, web accessible content read or shared, points earned for actions or promotions made or unique computer generated relevancy vectors (used, for instance, to make recommendations based on collaborative filtering data).

“user identifying data” may be defined for the current invention as specifically identifying data for a particular user. Such data may include a unique identifier utilized by the invention to label the user, a self-selected user ID, a user's identification from other social networks and unique computer generated indexes.

“context” may be defined for the current invention as a conceptual frame-of-reference or framework that facilitates the concatenation of web accessible content. For example, a user reading an article online about a particular disaster might, in the context of social action, concatenate a hyperlink to an opportunity for donation to the article but in the context of education might concatenate the hyperlink to relevant book or article. Contexts, as utilized in the current invention are human created constructs for understanding, categorizing and synthesizing information. A user may search though existing contexts or define new contexts and then apply the context to filter information before making a choice as to the content to be concatenated.

“intention” may be defined for the current invention as the desire of a user for other users to take a particular future action or actions. For instance, in the context of social action, a user may intend other users to make a donation that relates to a particular news article, thus their intention would read as “User X promoted News Article Y and thought that Donation Z was a good solution.” In this case the explicit intention is for the other users, who receive the output of the invention, to make donation Z. Likewise, also in the context of social action, a user might intend other users to read relevant and contrasting analysis that relates to the same news article, thus their intention would read as “User X promoted News Article Y and thought Article Z was worth reading.” In this case, the explicit intention is for the other users, who receive the output of the invention, to read Article Z.

“metadata” may be defined for the current invention as data about data and may include but is not limited to categories such as guide metadata that help humans locate specific items of data; structural metadata regarding the organization of the data; business metadata that may include metrics on data use; and descriptive metadata that may include elements such as time and date of data creation, the creator or author of the data, the location of the data, the size of the data, keywords that describe the data, etc. Note that sometimes user data or user identifying data can be metadata or simply data.

“user message” may be defined for the current invention as any type of comment from a user regarding the concatenated content. In certain embodiments, the user may send out a hyperlink together with a message. The hyperlink may contain all the concatenated information (user data, concatenated web pages, intent, context, etc.), but not the message. The user message may be stored in one or more databases, and may be associated in the one or more databases with the hyperlink.

In alternative embodiments, the one or more processors operate as a standalone device or may be connected, e.g., networked to other processors, in a networked deployment, the one or more processors may operate in the capacity of a server or a client machine in server-client network environment, or as a peer machine in a peer-to-peer or distributed network environment.

The software may further be transmitted or received over a network via a network interface device. While the network is shown in an exemplary embodiment to be a single medium, the term “network” should be taken to include a single medium or multiple media (e.g., a centralized or distributed database, and/or associated caches and servers) that store the one or more sets of instructions. The term “network” shall also be taken to include any medium that is capable of storing, encoding or carrying a set of instructions for execution by one or more of the processors and that cause the one or more processors to perform any one or more of the methodologies of the present embodiments. A carrier medium may take many forms, including but not limited to, non-volatile media, volatile media, and transmission media.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Furthermore, while some embodiments described herein include some but not other features included in other embodiments, combinations of features of different embodiments are meant to be within the scope of the claims, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element.

In the description provided herein, numerous specific details are set forth. However, it is understood that embodiments may be practiced without these specific details. In other instances, well-known methods, structures and techniques have not been shown in detail in order not to obscure an understanding of this description.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A system for concatenating web accessible content, the system comprising:
at least one server;
one or more databases in communication with the at least one server;
the at least one server executing a method comprising:
receiving a plurality of URLs wherein each of the plurality of the URLs is related to a distinct item of web accessible content;
receiving user data;
receiving user identifying data;
receiving metadata;
receiving a user message;
receiving at least one user intention by which URL concatenations may be made, wherein the at least one user intention is a description of a desired action to be taken by future users;
receiving at least one context by which URL concatenations may be made, wherein the at least one context is a conceptual frame-of-reference for possible concatenations between the web accessible content;
concatenating the plurality of URLs, the user data, the user identifying data, the metadata, and the at least one user intention within the at least one context to create concatenated content;
creating one or more new URLs for the concatenated content;
storing the concatenated content or one or more new URLs in the one or more databases;
storing the user message in the one or more databases; and
outputting the one or more new URLs together with the user message.

2. The system of claim 1, further comprising displaying the metadata related to the concatenated content.

3. The system of claim 1, wherein one of the plurality of URLs is a URL of a webpage the user is currently browsing.

4. The system of claim 1, wherein the plurality of URLs, the user data, the user identifying data, and metadata are chosen by a user, another computer or a recommendation system.

5. The system of claim 1, wherein the one or more new URLs are distributed by one or more of email, social networking, text message, and verbal output over telephone communication channels.

6. The system of claim 1, wherein computer sorted relevant information is presented to the user as a list from an existing database and the user can choose relevant information from the sorted list.

7. The system of claim 1, wherein the one or more new URLs are tiny URLs.

8. The system of claim 1, wherein the concatenated content is used to provide metrics regarding user actions and interests.

9. The system of claim 1, wherein the one or more new URLs facilitate action, by a receiving user, related to the at least one context and to the at least one user intention.

10. The system of claim 1, wherein the one or more new URLs each allow the display of a new webpage that comprises the web accessible content, the metadata, the concatenated content, the user message, the user intention, the user identifying data, the user data in a browser or other system that can display web accessible content.

11. The system of claim 1, wherein the one or more new URLs each allow the transfer of the web accessible content, the metadata, the concatenated content, and the user data to other computers.

12. A method for concatenating web accessible content with an existing webpage, the method comprising:
receiving a plurality of URLs wherein each of the plurality of the URLs is related to a distinct item of web accessible content;
receiving user data;
receiving user identifying data;
receiving metadata;
receiving a user message;
receiving at least one user intention by which URL concatenations may be made, wherein the at least one user intention is a description of a desired action to be taken by future users;
receiving at least one context by which URL concatenations may be made, wherein the at least one context is a conceptual frame-of-reference for possible concatenations between the web accessible content;
concatenating the plurality of URLs, the user data, the user identifying data, the metadata, the user message, and the at least one user intention within the at least one context to create concatenated content;
creating one or more new URLs for the concatenated content;
storing the concatenated content or one or more new URLs in the one or more databases;
storing the user message in the one or more databases; and
outputting the one or more new URLs together with the user message.

13. The method of claim 12, further comprising displaying the metadata related to the concatenated content.

14. The method of claim 12, wherein one of the plurality of URLs is a URL of a webpage the user is currently browsing.

15. The method of claim 12, wherein the plurality of URLs, the user data, the user identifying data, and metadata are chosen by a user, another computer or a recommendation system.

16. The method of claim 12, wherein the one or more new URLs are distributed by one or more of email, social networking, text message, and verbal output over telephone communication channels.

17. The method of claim 12, wherein computer sorted relevant information is presented to the user as a list from an existing database and the user can choose relevant information from the sorted list.

18. The method of claim 12, wherein the one or more new URLs are tiny URLs.

19. The method of claim 12, wherein the concatenated content is used to provide metrics regarding user actions and interests.

20. The method of claim 12, wherein the one or more new URLs facilitate action, by a receiving user, related to the at least one context and to the at least one user intention.

21. The method of claim 12, wherein the one or more new URLs each allow the display of a new webpage that comprises the web accessible content, the metadata, the concatenated content, the user message, the user intention, the user identifying data, and the user data in a browser or other system that can display web accessible content.

22. The method of claim 12, wherein the one or more new URLs each allow the transfer of the web accessible content, the metadata, the concatenated content, and the user data to other computers.
